(19) United States
(12) Patent Application Publication
(10) Pub. No.: US 2006/0064506 A1
(43) Pub. Date: Mar. 23, 2006

(54) Network architecture that supports a dynamic IP addressing protocol across a local exchange bridged network

(76) Inventor: Gregory David Mielke, Miramar, FL (US)

Correspondence Address: LAW OFFICES OF MARK C. PICKERING, P.O. BOX 300, PETALUMA, CA, 94953, US

(21) Appl. No.: 10/118,818

(22) Filed: Apr. 9, 2002

(51) Int. Cl. G06F 15/173

(52) U.S. Cl. 709/244

(57) ABSTRACT

A network architecture that supports a dynamic protocol on a local exchange bridged network is implemented by utilizing a bridge to provide an interface between a piece of customer premise equipment (CPE) and a modem. By utilizing a bridged modem, the CPE used by each customer can be mapped to a different virtual local area network (VLAN).

### BACKGROUND OF THE INVENTION

1. Field of the Invention

The present invention relates to network architectures and, more particularly, to a network architecture that supports a dynamic IP addressing protocol across a local exchange bridged network.

2. Description of the Related Art

A mixed service telecommunications architecture is an architecture for delivering video, data, and voice services over a conventional twisted-pair telephone wire to customer premise equipment (CPE) at a customer location. The services and supporting CPEs are often provided by different service providers, with a set-top box for video from a first supplier, internet service from a second supplier, and plain old telephone service (POTS) from a third supplier.

FIG. 1 shows a block diagram that illustrates a portion of a prior-art mixed service telecommunications architecture 100. Architecture 100 includes an asynchronous transfer mode (ATM) network 110 that has a number of interconnected ATM switches AT1-ATg, and a number of edge devices ED1-EDm that are connected to the switches AT1-ATg.

Each edge device ED converts data from an input data format to an ATM format. In the ATM format, data is loaded into fixed length packets known as cells. Each cell has a header section and a data section. The header section, in turn, includes a virtual connection identifier (VCI) that identifies the destination of the cell.

Architecture 100 further includes a local exchange bridged network 112 that is connected to edge device ED1, an internet server 114 that is connected to edge device ED2, and a video server 116 that is connected to edge device ED3. Bridged network 112, in turn, includes a number of bridges BR1-BRn that are connected to edge device ED1, and a number of xDSL modems DS that are connected to each bridge BR. In addition, each bridge BR has a number of ports PT1-PTj, with each modem DS being connected to one of the ports PT. Further, a number of CPEs, such as set top boxes ST and personal computers PC, are connected to each modem DS.

In operation, when a CPE, such as a set top box or personal computer, boots up, the CPE outputs a data packet to its associated modem which, in turn, outputs the data packet to its associated bridge. The data packet includes the address of a video server (the packet destination), and the internet protocol (IP) address (which includes the MAC address) of the CPE.

The associated bridge receives the data packet on one of its ports, determines the destination of the data packet, and forwards the data packet to the destination address. When the destination address is not connected to the associated bridge, the bridge forwards the data packet to other locally connected bridges and the ATM network via an edge device. The ATM network then forwards the cells to the destination address.

For example, when set top box ST1 boots up, set top box ST1 outputs a data packet to modem DS1 which, in turn, outputs the data packet to bridge BR1. Bridge BR1 receives the data packet from modem DS1 on port P1. Bridge BR1 does not know if the data packet came from set top box ST1 or personal computer PC1, only that the packet came from port P1.

Bridge BR1 determines the destination of the data packet, and forwards the data packet to the destination address. When the destination address is not connected to bridge BR1, bridge BR1 forwards the data packet to edge device ED1 and bridges BR2-BRg. Edge device ED1 receives the data packet, converts the data packets into ATM data cells, and forwards the cells to switch AT1.

Switch AT1 examines the VCI in the header, and routes the cell to one of a number of ATM switches based on the VCI. Each succeeding ATM switch that receives the cell repeats the process until the cell reaches its destination. The examination and routing is performed in hardware without software support. As a result, ATM network 110 is able to provide high-speed data communication.

In the present example, switch AT1 forwards the cells to switch AT3. Edge device ED3 converts the data cells received by switch AT3 into a local data format, and passes the data onto video server 116. Video server 116 outputs a response back to set top box ST1 that includes, in addition to other information, boot up information for box ST1. (A similar process occurs with internet server 114 when a personal computer boots up for network access.)

One severe limitation of architecture 100 is that each CPE (each set top box ST and each personal computer PC) in architecture 100 has a static IP address. In addition, each CPE has a fixed address from which to obtain start up (boot strap) information. This requires complex customer installations, network configurations, and coordination between the different service providers.

A much simpler and lower cost approach is to utilize a dynamic addressing scheme to assign IP addresses on a temporary basis as the IP addresses are needed. With a dynamic protocol, such as the dynamic host configuration protocol (DHCP), a CPE, such as a set top box, is a member of a virtual local area network (VLAN).

In the protocol, the CPE requests an IP address from an unknown source in the VLAN (only one device in the VLAN responds to the IP address request), thereby eliminating the need to have a fixed address for boot strap information. In addition, the device is assigned a new IP address each time the set top box boots up, thereby eliminating the need to have static IP addresses.

Thus, with a dynamic protocol, a technician does not need to manually set a static IP address for a device, or manually set the destination address of the boot strap server, because the device is assigned a new IP address from an unknown server each time the device goes onto the network. This makes rolling out new equipment significantly easier for the service providers.

Current generation, local exchange bridged networks, however, are incompatible with dynamic protocols. FIG. 2 shows a schematic diagram that illustrates a hypothetical, dynamic protocol, bridged network architecture 200. Network architecture 200 is similar to network architecture 100 and, as a result, utilizes the same reference numerals to designate the structures that are common to both architectures. As shown in FIG. 2, architecture 200 differs from architecture 100 in that architecture 200 includes a DHCP internet server 214 in lieu of internet server 114, and a DHCP video server 216 in lieu of video server 116.

In operation, when set top box ST1 boots up, set top box ST1 outputs a data packet to modem DS1 which, in turn, outputs the data packet to bridge BR1. The data packet includes a destination address, and the MAC address of the sending device which, in the present example, is set top box ST1. When initiating a boot strap protocol, the destination address is a dynamic host configuration protocol (DHCP) request.

Bridge BR1 receives the data packet on port P1. As in the previous example, bridge BR1 does not know if the data packet came from set top box ST1 or personal computer PC1, only that the packet came from port P1. Bridge BR1 determines whether the data packet is a broadcast packet, which is to be broadcast to each other member of the VLAN, or a routed packet which is to be routed to a specific address.

When the destination address is a DHCP request, bridge BR1 regards the data packet as a broadcast packet. In this case, bridge BR1 turns to a look-up table to identify the other members of the VLAN of port P1, and output the data packet to each member of the VLAN. In this case, because set top box ST1 requires a DHCP video server and personal computer PC1 requires a DHCP internet server, the video server and the internet server are both included in the same VLAN. As a result, the data packet containing the request is sent to both the video server and the internet server.

For devices that are not connected to bridge BR1, bridge BR1 outputs the data packet to edge device ED1 and bridges BR2-BRg. Edge device ED1 receives the data packets addressed to the different devices, converts the data packets into ATM data cells, and forwards the cells to switch AT1. Switch AT1 then forwards the cells to switches AT2 and AT3.

All works well if switch AT3 is the first to receive the cells that include the DHCP request. In this case, edge device ED3 converts the data cells received by switch AT3 into a local data format, and passes the data onto DHCP video server 116. DHCP video server 116 links an IP address to the MAC address of set top box ST1, and outputs a response back to set top box ST1 identifying the IP address (along with other information boot up information).

On the other hand, if switch AT2 is the first to receive the cells that include the DHCP request, edge device ED2 converts the data cells received by switch AT2 into a local data format, and passes the data onto DHCP internet server 114. DHCP internet server 114 links an IP address to the MAC address of set top box ST1, and outputs a response back to set top box ST1 identifying the IP address. In this case, set top box ST1 begins to communicate with internet servers rather than video servers, and the system fails.

One solution to this problem has been to utilize a dynamic protocol with video, and install special recognition software (e.g., PPPoE and PPPTP) on the personal computers that allows IP address negotiation. This approach, however, requires each personal computer to run additional client software, and creates additional support costs for service providers.

Another limitation of architecture 100 is that each CPE (each set top box ST and each personal computer PC) in architecture 100 contends for Ethernet bandwidth. One solution to this problem has been to prioritize IP addresses. Although workable, this approach adds another layer of complexity.

Thus, there is a need for a network architecture that supports a dynamic protocol on a local exchange bridged network, and reduces contention for Ethernet bandwidth.

### SUMMARY OF THE INVENTION

The present invention provides a network architecture that supports a dynamic protocol on a local exchange bridged network by utilizing a bridge to provide an interface between a piece of customer premise equipment (CPE) and a modem. By utilizing a bridge, each piece of CPE can be mapped to a different virtual local area network (VLAN). This allows a dynamic protocol to be used on local exchange bridged network systems, thereby significantly simplifying the process for rolling out and maintaining new CPE-based services. In addition, the present invention reduces contention for Ethernet bandwidth.

A network architecture in the present invention comprises a bridged modem that includes a bridge circuit. The bridge circuit has a receiving circuit that has a plurality of customer premise equipment (CPE) ports. Each CPE port, in turn, is associated with a VLAN. The receiving circuit forms a received data packet when a data packet is received from a CPE port.

The bridge circuit also has an address identifier circuit that is connected to the receiving circuit. The address identifier circuit determines whether the received data packet includes an IP address request. In addition, the bridge circuit has a look up circuit that identifies a member of a VLAN when the received data packet includes an IP address request.

The bridge circuit further includes an output circuit that is connected to the address identifier circuit and the look up circuit. The output circuit generates an addressed data packet that is addressed to the member of the VLAN, and forwards the addressed data packet from a bridge output after the addressed data packet has been generated.

The modem also includes a modem circuit that has a receiving circuit which is connected to the bridge output. The receiving circuit receives the addressed data packet from the output circuit. The modem circuit also includes a modulation circuit that is connected to the receiving circuit. The modulation circuit modulates the data in the packet to form a data signal. In addition, the modem circuit includes a transmitting circuit that is connected to the modulation circuit. The transmitting circuit transmits the data signal from a transmit port.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating a portion of a prior-art mixed service telecommunications architecture 100.

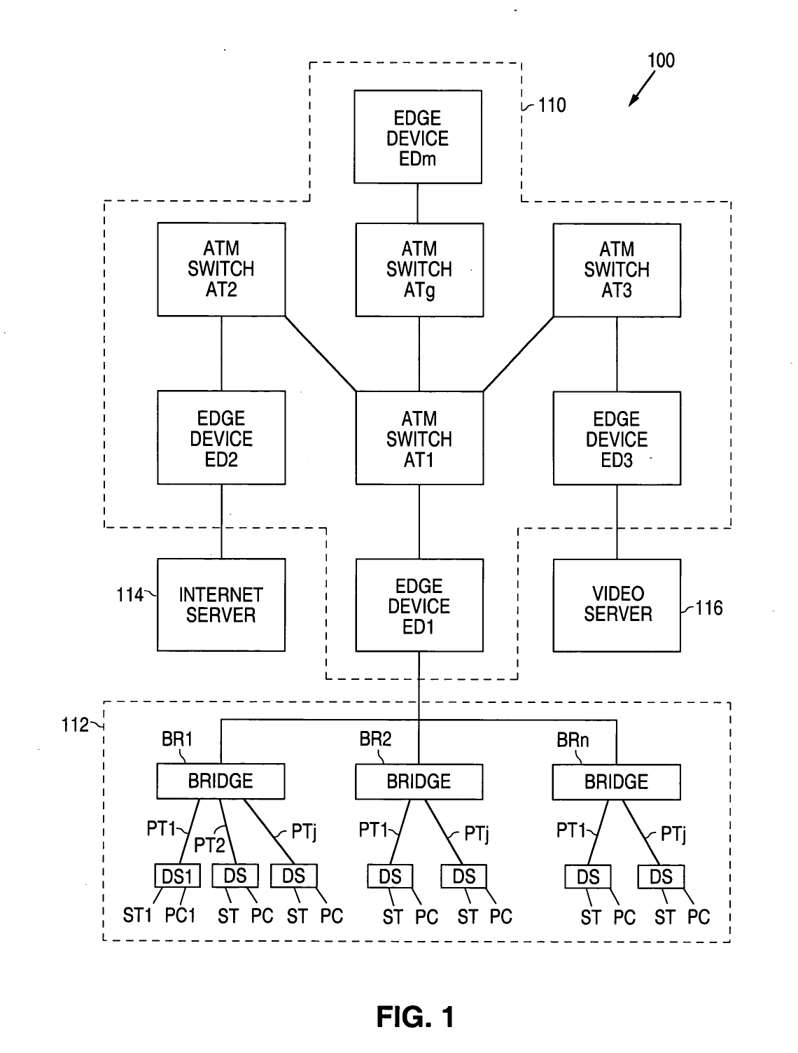

FIG. 2 is a schematic diagram illustrating a hypothetical, dynamic protocol, bridged network architecture 200.

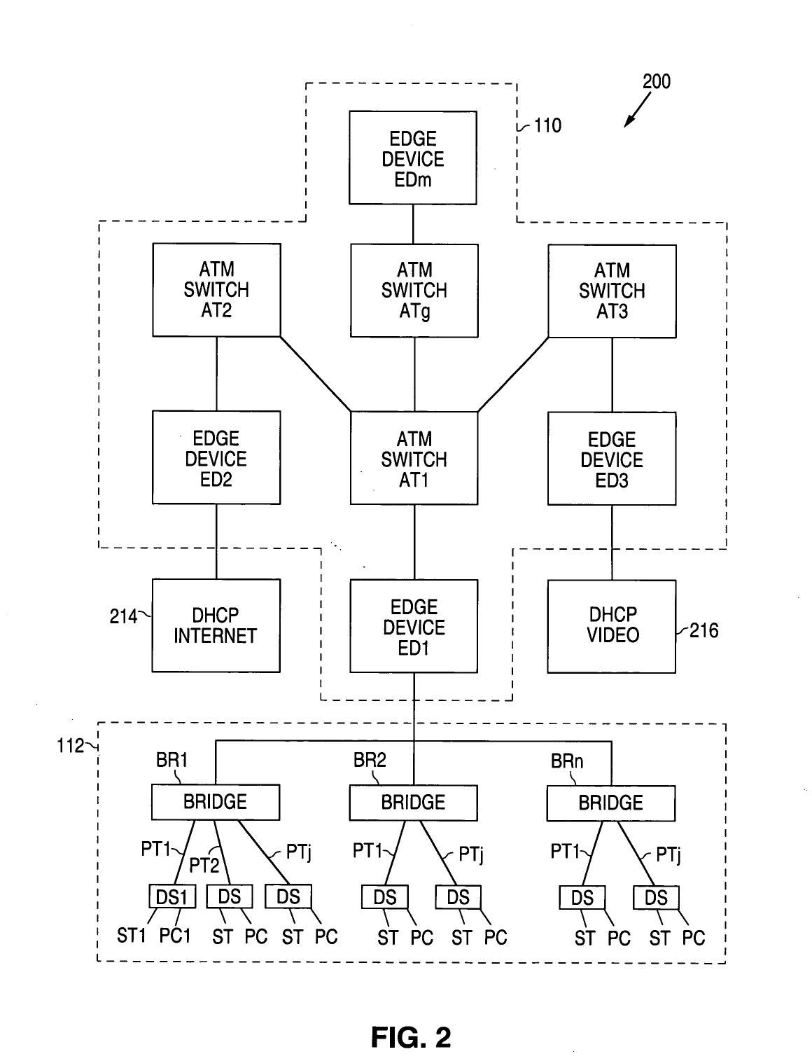

FIG. 3 is a block diagram illustrating a network architecture 300 in accordance with the present invention.

FIG. 4 is a block diagram illustrating a bridged modem 400 in accordance with the present invention.

### DETAILED DESCRIPTION

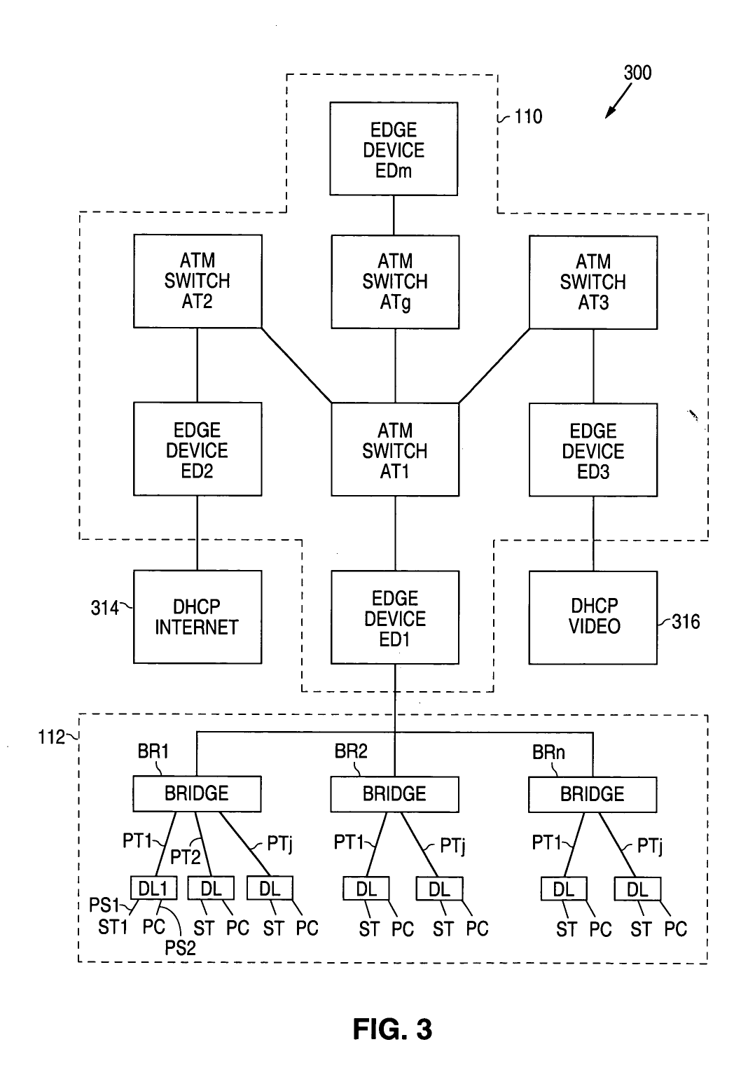

FIG. 3 shows a block diagram that illustrates a network architecture 300 in accordance with the present invention. Architecture 300 is similar to architecture 100 and, as a result, utilizes the same reference indicators to indicate the structure that is common to both architectures.

As shown in FIG. 3, architecture 300 differs from architecture 100 in that architecture 300 includes a DHCP internet server 314 in lieu of internet server 114, and a DHCP video server 316 in lieu of video server 116. In addition, architecture 300 utilizes a number of bridged modems DL in lieu of xDSL modems DS. Bridged modems DL differ from standard xDSL modems DS in that a bridged modem DL includes an Ethernet bridge that maps a MAC address to a specific ATM address, and an xDSL modem circuit.

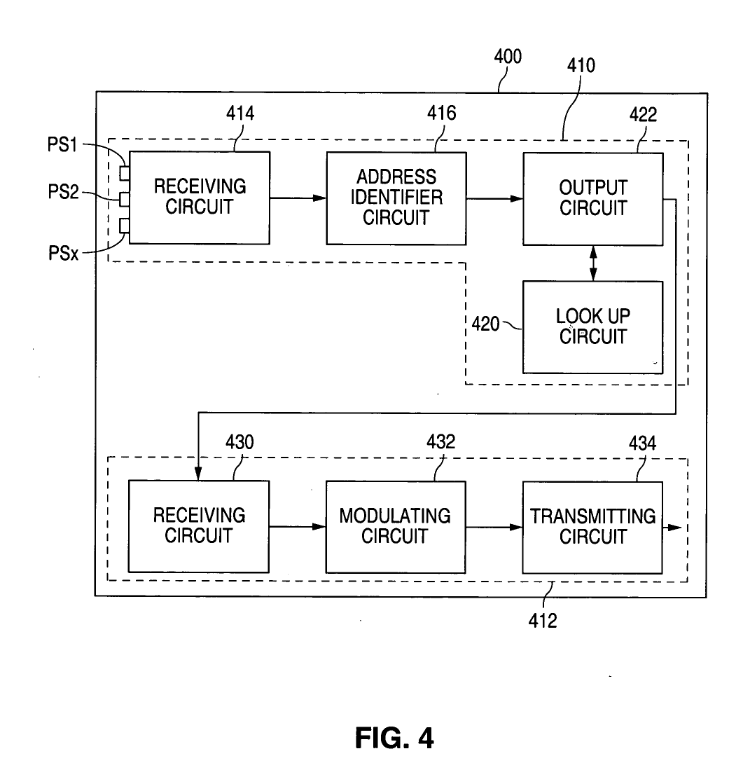

FIG. 4 shows a block diagram that illustrates a bridged modem 400 in accordance with the present invention. As shown in FIG. 4, bridged modem 400 has a bridge circuit 410 and an xDSL modem circuit 412. Bridge circuit 410, in turn, includes a receiving circuit 414 that has a series of customer premise equipment (CPE) ports PS1-PSx. Each CPE port PS is associated with a virtual local area network. In operation, receiving circuit 414 forms a received data packet when a data packet is received from a CPE port PS.

As further shown in FIG. 4, bridge circuit 410 includes an address identifier circuit 416 that is connected to receiving circuit 414. In operation, address identifier circuit 416 examines the received data packet to determine whether a DHCP IP address request is present. Bridge circuit 410 further includes a look up circuit 420 that identifies the members of the VLAN when an IP address request is present in the received data packet.

In addition, bridge circuit 410 includes an output circuit 422 that is connected to address identifier circuit 416 and look up circuit 420 that generates an addressed data packet for each member of the VLAN. Further, output circuit 422 forwards the addressed data packet from a bridge output after the addressed data packet has been generated.

As noted above, in addition to bridge circuit 410, bridged modem 400 also includes xDSL modem circuit 412. Modem circuit 412 includes a receiving circuit 430 that is connected to the bridge output to receive the addressed data packet from output circuit 422. In addition, modem circuit 412 includes a modulation circuit 432 that is connected to receiving circuit 430 that modulates the data in the packet to form a data signal. Further, modem circuit 412 includes a transmitting circuit 434 that is connected to modulation circuit 432. Transmitting circuit 434 transmits the data signal from a transmit port.

In operation, when a device, such as a set top box or a computer, boots up, the device outputs a data packet that includes a DHCP IP address request, and the MAC address of the device. The port PT connected to the device receives the data packet, while receiving circuit 414 forms the received data packet.

Following this, address identifier circuit 416 determines whether the received data packet includes a DHCP IP address request. When no DHCP IP address request is present, output circuit 420 determines whether the received data packet is a broadcast packet, which is to be broadcast to each other member of the VLAN, or a routed packet which to be routed to a specific address.

When a DHCP address request is present, output circuit 422 regards the received data packet as a broadcast packet. In this case, output circuit 422 turns to a look-up table in look up circuit 420 to identify the other members of the VLAN that is associated with the receiving port PT. After this, output circuit 422 generates an addressed data packet for each member of the VLAN.

In the invention, only one type of DHCP server is a member of the VLAN. As a result, the addressed data packet that includes the DHCP request can only go to the correct DHCP server. For example, when the device is a set top box, the port PT connected to the set top box is associated with a VLAN that includes DHCP video server 316, but does not include DHCP internet server 314.

Similarly, when the device is a personal computer, the port PT connected to the computer is associated with a VLAN that includes DHCP internet server 314, but does not include DHCP video server 316. As a result, the addressed data packet that includes the DHCP IP address request can only go to the correct DHCP server.

Output circuit 422 forwards the addressed data packet to modem circuit 412 which, in turn, outputs the data packet signal to bridge BR1 shown in FIG. 3. Bridge BR1 determines the destination address, and forwards the data packet to edge device ED1 and bridges BR2-BRn. Edge device ED1 receives the data packet, converts the data packet into ATM data cells, and forwards the cells to switch AT1.

Switch AT1 examines the VCI in the header, and routes the cell to one of a number of ATM switches based on the VCI. Each succeeding ATM switch that receives the cell repeats the process until the cell reaches its destination. The examination and routing is performed in hardware without software support.

In the present example, switch AT1 forwards the cells to switch AT3. Edge device ED3 converts the data cells received by switch AT3 into a local data format, and passes the data onto DHCP video server 316. Video server 316 outputs a response back to the device that includes IP address and boot up information (in addition to other information). (A similar process occurs when a personal computer boots up for network access.)

In addition to providing a network architecture that supports a dynamic protocol, network architecture 300 of the present invention also reduces collisions on the network. This is because video traffic and data traffic are mapped to separate VLANs which are separate collision domains.

In an alternate embodiment of the present invention, in addition to mapping different types of service (e.g., set top boxes and internet) to different VLANS, bridge circuit 410 also maps different classes of service to different VLANs. For example, IP address requests from a set top box ST can be mapped to a VLAN that provides the highest quality of service, while IP address requests from a personal computer for internet service can be mapped to a VLAN to provides a much lower quality of service. This is important when users wish to give priority to the video as opposed to, for example, internet e-mail traffic.

It should be understood that various alternatives to the method of the invention described herein may be employed in practicing the invention. Thus, it is intended that the following claims define the scope of the invention and that methods and structures within the scope of these claims and their equivalents be covered thereby.

1. A network architecture comprising:
a modem comprising:
a bridge circuit having:
a receiving circuit having two or more local ports, each local port being associated with a virtual local area network (VLAN), each local port associated with a different type of service being associated with a different VLAN, the receiving circuit forming an outgoing data packet when a data packet is received from a device connected to a local port,
an address identifier circuit connected to the receiving circuit that determines whether the outgoing data packet includes a request to determine an address of the device,
a look up circuit that identifies each member of the VLAN associated with the local port when the outgoing data packet includes the request to determine the address of the device, and
an address output circuit connected to the address identifier circuit and the look up circuit that forwards the outgoing data packet on towards each member of the VLAN.

2. The network architecture of claim 1 and further comprising:
a network bridge having a receiving circuit having two or more modem ports, a modem port being electrically connected to the modem to receive the outgoing data packet;
a communications network connected to the network bridge;
a first dynamic protocol server electrically connected to the communications network, the first dynamic protocol server being associated with a first type of service and a first VLAN; and
a second dynamic protocol server electrically connected to the communications network, the second dynamic protocol server being associated with a second type of service and a second VLAN.

3. The network architecture of claim 2 wherein the communications network includes a plurality of edge devices, a first edge device being connected to the network bridge, the first edge device receiving the outgoing data packet, converting the data from the outgoing data packet from a first format into a second format, and outputting the data in the second format.

4. The network architecture of claim 3 wherein the second format includes an asynchronous transfer mode (ATM) format.

5. The network architecture of claim 3 wherein the communications network further includes a plurality of interconnected switches, a first switch being connected to the first edge device, a second switch being connected to a second edge device, a third switch being connected to a third edge device, the first dynamic protocol server being electrically connected to the second edge device, and the second dynamic protocol server being electrically connected to the third edge device.

6. The network architecture of claim 5 wherein a set top box is connected to the local port.

7. The network architecture of claim 5 wherein a personal computer is connected to the local port.

8. The network architecture of claim 5 wherein a set top box is connected to a first local port, and a personal computer is connected to a second local port.

9-11. (canceled)

12. A method of determining an address, the method comprising:
forming an outgoing data packet when a data packet is received from a device connected to a local port of two or more local ports, the local port being associated with a virtual local area network (VLAN), each local port associated with a different type of service being associated with a different VLAN;
determining whether the outgoing data packet includes a request to determine an address of the device;
identifying each member of the VLAN associated with the local port when the outgoing data packet includes the request to determine the address of the device; and
forwarding the outgoing data packet on towards each member of the VLAN.

13. The method of claim 12 and further comprising:
receiving the outgoing data packet;
determining a destination address of the outgoing data packet, and
forwarding the outgoing data packet as a forwarded addressed data packet based on the destination address.

14. The method of claim 13 and further comprising:
receiving the forwarded addressed data packet;
converting the data from the forwarded addressed data packet from a first format to a second format; and
outputting the data in the second format.

15. The method of claim 14 wherein the second format includes an asynchronous transfer mode (ATM) format.

16. The network architecture of claim 11 wherein a set top box is connected to the local port.

17. The method of claim 11 wherein a personal computer is connected to the local port.

18. The method of claim 11 wherein a set top box is connected to a first local port, and a personal computer is connected to a second local port.

19. The network architecture of claim 1 wherein each VLAN includes only one address provider.

20. The network architecture of claim 1 wherein the different types of service include video service and internet service.

21. The network architecture of claim 2 wherein the modem further includes a transmitter circuit having:
a receiving circuit connected to the address output that receives the outgoing data packet,
a modulation circuit connected to the receiving circuit of the transmitter circuit that modulates the data in the packet to form a data signal, and
a transmitting circuit connected to the modulation circuit and the network bridge, the transmitting circuit transmitting the data signal.

22. The method of claim 12 wherein each VLAN includes only one address provider.

23. The method of claim 12 wherein the different types of service include video service and internet service.
